(19) United States
(12) Patent Application Publication
(10) Pub. No.: US 2026/0337891 A1
(43) Pub. Date: Oct. 29, 2026

(54) PRESS MOLDING METHOD OF A FIBER PRODUCT, A FIBER PRESS MOULD AND A FIBER PRODUCT

(71) Applicant: Blue Ocean Closures AB, Karlstad (SE)

(72) Inventor: Lars Sandbergs, Hammarö (SE)

(73) Assignee: Blue Ocean Closures AB, Karlstad (SE)

(21) Appl. No.: 19/114,342

(22) PCT Filed: Sep. 22, 2023
(86) PCT No.: PCT/EP2023/076285

§ 371 Date: Mar. 21, 2025

(30) Foreign Application Priority Data
Sep. 23, 2022 (SE) 2251101-8
May 31, 2023 (SE) 2350669-4

(51) Int. Cl. D21J 3/10

(52) U.S. Cl. CPC D21J 3/10

(57) ABSTRACT

This invention relates to a press molding method of a fiber product, at high pressure and high temperature, by means of a press pad device (2) and a stamp device (3,4), wherein said fiber product (1) comprises a bottom part (11) and an edge part (10), characterized by said stamp device (3, 4) comprising two stamp members (3, 4), wherein a first stamp member (3) forms at least said bottom part (11) and a second stamp member (4) forms said edge part (10). This invention also relates to fiber press mould (2, 3, 4) and a fiber product (1).

### TECHNICAL FIELD

This invention relates to a press molding method of a fiber product, at high pressure and high temperature, by means of a press pad device and a stamp device, for performing the method.

### TECHNICAL BACKGROUND

A fiber product can be made by pressing a web or a sheet of fibers. Typically, a combination of natural fibers (e.g. wood pulp fibers), synthetic fibers (e.g. polyolefin-based fibers such as those made of e.g. polyethylene) and other additives such as binder or dye. In many applications it is preferred that such a web essentially merely comprises of natural fiber, with or without additives. Typical process conditions are 150-250 °C and pressures 100-10000 bar (200-2000 Bar). Moisture content may typically be less than 20%.

The fiber product can be in the form of a hollow product, for example a package or a closure (lid, screw cap or similar), but can also be a flat product. Products can be formed from a web of the material and punched/cut in connection with forming, e.g. that have been completely or partially separated from the web to allow deeper shaping. This exposure is typically done by cutting the material into a shape that is adapted to the final shape. Typically, for example, a roundel is cut to form a round package.

The press molding typically takes place with two tools where both the outer tool pad and the inner tool (stamp) can consist of several parts to enable discharge of the finished product. Typically, the pad opens while the stamp collapses. The piston, parts of the piston or parts of the pad can also be made of a compressible material which enables greater vertical compressive forces, typically against the sides of the cavity, by the tool material being reshaped during the compression.

Examples of known methods described above are shown in EP 3 736 099 and WO 2020/165780.

Also, a rigid board container is known from U.S. Pat. No. 4,606,496A.

### SUMMARY OF THE INVENTION

It is an object of the invention to optimize at least in some applications regarding the production of cup shaped press molded fiber products, which is a achieve by a method as defined in claim 1 and/or a fiber press mould as defined in claim 12.

Thanks to the invention a more homogenous product may be achieved, that may provide for obtaining a more even quality of a cup shaped press molded fiber product.

### DESCRIPTION OF FIGURES

In the following, the invention will be described with reference to a preferred embodiment of a schematic pressing mould according to the invention by schematically describing a press mould of a preferred example, in which FIG. 1 shows a schematic cross-sectional view of a fiber press mould when performing the method as set out in claim 1 above.

FIG. 2 highlights a further preferred embodiment viz. when there is created a threaded press molded fiber product having protrusions. FIG. 2 provides a cross-sectional view of the molded product from the side. This preferred embodiment provides for a sealing possibility by e.g. using a screw cap that have grooves (that fit with the protrusions, which may be present inside or outside, i.e. the threading) for providing a sealed or partly-sealed container such as a cup or similar. Also, a screw cap that may fit over a container may be provided using a similar approach as set out in FIG. 2.

### DETAILED DESCRIPTION

In FIG. 1 there is shown a fiber press mould, comprising a press pad device 2 and a stamp device 3, for forming a cup shaped fiber product 1. The cup shaped fiber product 1 comprises side walls 12 between an upper edge part 10 and the bottom part 11. The stamp device 3 may be solid in one piece or divisible into two or more pieces. Said device, may further be collapsible The press pad device 2 comprises a body 20 arranged with a cavity (or recess) 22. The cavity 22 comprises a bottom surface 23 and sidewalls 24. Said body 20 may be solid or divisible into two or more pieces.

The stamp member 3 comprises a body 30 adapted to fit into the cavity 22 such that a gap may be formed between the side surface 34 thereof and the sidewalls 24 of the cavity, whereby a desired thickness t12 of the side walls 12 of the fiber product may be achieved.

The press molding method as set out in claim 1, may also involve that an upper edge (10) of said fiber product (1) after forming at least said bottom part (11) is positioned within a cavity (22) of said press pad device (2), wherein preferably all parts of said upper edge (10) is positioned below an upper surface of the body (20) of said press pad device (2).

The material in the fiber product 1 comprises natural fibers such as natural fibers from wood, straw, such as bagasse, and/or recycled wood fibers or a combination thereof, preferably natural wood fibers, most preferred virgin natural wood fibers, or when sustainability is of importance re-cycled wood fibers may be preferred.

Further, the amount of water in pre-cut blank (e.g. roundel) prior to pressing shall not exceed 20% the weight of fiber.

The material in fiber product 1 may also comprise pre-expanded microspheres and/or expandable microspheres.

The material in fiber product 1 may also comprise a fiber mat produced though airlaid technology and/or a fiber mat produced through wetlaid technology The material in fiber product 1 may also comprise paper sheet, wherein preferably said sheet has a moist content of from about 4 to about 25%, most preferred from about 7 to about 15 %.

When using the mould for press molding of a fiber product 1, a pre-cut blank (not shown per se) is introduced into the cavity 22 of the press pad device 2. Thereafter the stamp member 3 is applied with a force F1 to move down into the cavity 22 and will then form the product. High temperature is used during production and high pressure is applied by means of the press pad device 2 and the stamp device 3 and optionally by means of an additional stamp device 4, whereby said additional stamp device 4 may be a separate stamp device or be part of the stamp device 3, i.e. creating one entity), to form the fiber product 1. The molding temperature may be from about 80 to about 250 °C, preferably from about 150 to about 250 °C , and the applied pressure by the stamp 3 and additional stamp device 4, is at least 200 bar. The pressure may further be applied so that it is from about 500 to about 1000 bar. Said press pad device 2 may further be in one piece or it can be made up from two or more pieces., wherein one piece is preferred.

Preferably the arrangement is such (e.g. sensor controlled) that the stamp member 3 stops pressing at a given distance in relation to a position of the press pad device 2, such that a given thickness t11 is achieved for said bottom part 11.

As generally known, a cup shaped product is arranged with generally vertical wall parts 12, wherein the expression generally vertical shall be given a broad interpretation.

As shown in FIG. 1 the generally vertical wall parts 24 of the pad device 2 is arranged with an angle a in relation to the vertical that is larger than the corresponding angle β of the generally vertical wall parts walls of the stamp device 3, thereby forming an (at least partly) upwardly diverging gap shaping said generally vertical wall parts 12.

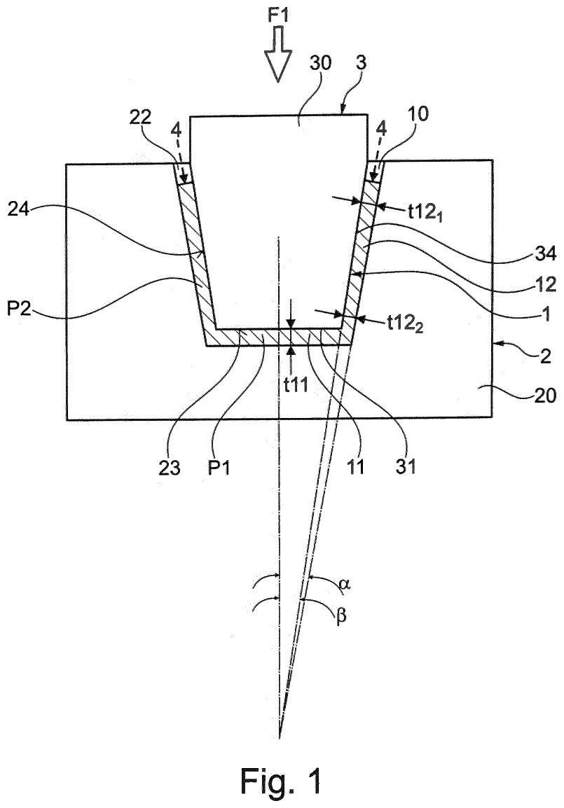

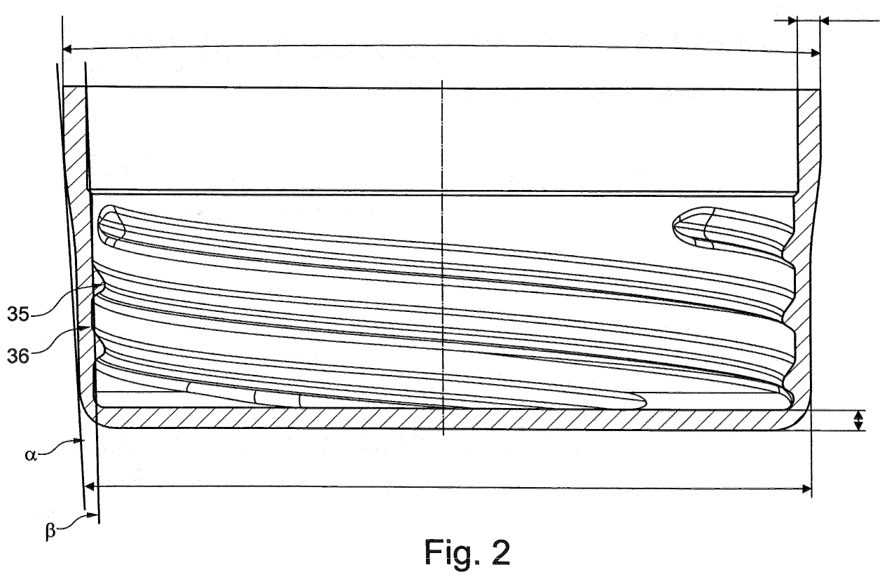

α and β in FIG. 1 when pointing, also shows average surface lines that create the angles α and β. The angle β may even be parallel with the Y-axis in said FIG. 1. Said average surface lines also appear in FIG. 2 where there is a threading 35 present as mentioned above which protrudes. At the same time there are dimples 36 corresponding to said threading creating valleys. When threads are made into the container using the method of claim 1 as set out above, then these average surface lines are more highlighted (as can be seen in FIG. 2).

Thanks to this design a more even density may be achieved in said generally vertical wall parts 12, due to the dynamics occurring during the press forming.

In the following the dynamics mentioned above will be discussed in greater detail. When forming a cup shape like or other 3D shape from a flat object the material is forced into a new shape. Specifically, when forming an object that resembles in-between a circular or oval cylinder and a box with bottoms and sides from a flat blank the material needs to be stretched or compressed. If the bottom of the structure is not stretched but basically holds its original shape, the sides need to be compressed.

Specifically, in a forming operation where a soft felt like material is formed into shapes like the above in order to then be sintered into shape, the forming process will comprise three major steps, i.e. a folding down step, forming step and a sintering step.

Draping is when the material is folded down into the cavity 22 in the pad 2, e.g. by means of the stamp 3, or another tool, i.e. pushing it down. Hence, it is referred to this operation as draping.

The forming step is when the stamp 3 pushes the material towards the sides 24 and bottom 23 of the cavity 22, giving the product its shape. Here material is transferred in the planes of the formed object, locally moving mass from areas with high amount of material to areas with lower amounts of material, hence locally evening out the density of the material.

In the sintering process the material is fused in place typically using heat, high pressure and/or chemical reactions.

If transfer of the material is limited and the density can vary, for example with a material that are built up by particles or fibers (rather than melting to a low viscosity), the density variation of the material will depend of the amount of material that was originally folded down to a given section of the cavity 22 that forms the object and, on the volume, allowed by the open space in-between the pad 2 and the stamp 3.

There are several reasons to strive towards an even distribution of density in the formed product. One is that mechanical properties depend on the density of the sintered material. The other is that the pressure given by the forming process is also dependent on the local density wherein low density may risk creating an insufficient sintering process and high pressure may cause friction in the forming operation risking to rip or distort the material.

The local density and density variation can be affected through allowing for more volume where needed and/or by controlling the folding process.

In one example a round blank is to be formed into a cup shaped object built up by its bottom 11 and walls 12. The average amount of material in a given position of the wall 12 of the is a function the positions height from the bottom of the cylinder. If using a constant size of the gap may result in that the higher up, the more the original projection of the blank is distorted to the new projection of the formed object according to a geometrical position. By compensating for that by means of an increased volume in-between the sides 24, 34 of two parts of the forming tools 2, 3 the density can be monitored and kept more constant. In this way the mechanical properties of the object, the functionality of the process and the effect of the sintering pressure can be improved. Typically, all of these functions are much improved if the density in all parts of the formed product is kept with +/−30% or ideally +/−10% of the average density.

For any given object and shape the ideal function for a desired volume of the side walls 12 can be calculated using the geometrical shape, the lateral position and the height from the bottom. According to the invention the average wall volume will increase from parts close to the bottom 11 to parts close to the upper edge 10. Hence, the wall thickness t12₂ close to the bottom 11 will be less than the wall thickness t12₁ adjacent the edge 10. At the top of the wall t12₁ may preferably be within +/−30% of t12₂ (d+h)/d, wherein d is the width (e.g. diameter) of the bottom 11 and h is the height, i.e. distance from bottom 11 to upper edge 10. For a low structure (d+h) almost=d the effect is neglectable. For a high structure the effect is significant for example if d=30 and h=15 mm the ideal average t12₁ may preferably be close to 1.5 times larger than t12₂.

In one embodiment design features like dents or outgoing structures may be used to create volume deviation on the structure wall. One example could be for a screw cap in the general form of a cylinder where threads are causing dents and outgoing structures on the inside of the cap while small groves for gripping may cause local deviations on the outside of the cap.

In such cases an average cross section volume over the height of the walls can be used. The average cross section volume will then be compensated so that the increase of volume to get the same density is achieved.

In the first part of the forming operation, i.e. draping when the blank is dragged down to the forming cavity, it will be folded and thereafter compressed in sections related to these folds. If the distance between the fold is too big areas may be created with high density far from each other, wherein internal transfer of material during the sintering pressure may not be able to sufficiently to even out the density profile. The grammage may also be of importance in this context.

Several strategies can be applied to improve control of the folding structure, e.g.:
Making dents or creases in the blank initiating the folds
Making cuts in the blank initiating the folds
Holding the fold in place on strategic locations when initiating the draping part of the process
Shaping the rim of the blanks initiating folds.
Shaping the upper part of the cavity rim so that it initiates the folds where wanted.

Further, the invention may in some applications be beneficially combined with the usage of a second stamp member (not shown), as presented in more detail in our already filed Swedish patent application 2151225-6, which is herewith introduced by way of reference. Hence, if using a process where the entire pre-cut blank may be pressed down into the pad 2 and below the upper end surface of the pad 2 and in subsequent step form the upper edge part 10 by second pressing tool, a product may be achieved with a predefined upper edge 10. The second stamp member can be seen as creating a kind of reshaping, which may also assist in shaping inward or outward formations with a varying gap thickness or shape such as, for example, embossments, stiffeners or threads. An additional benefit is that the shaping of faces having precise patterns or profiles may be achieved, e.g. shapes that are not possible to achieve if cutting is needed to shape the final product.

According to a preferred embodiment of the press molding method as set out above for claim 1, a pressure (F2) may also put on the edge part (10), wherein preferably said pressure is the same or different from F1, i.e. the one affecting the bottom part (11).

According to a preferred embodiment of the press molding method as set out above for claim 1, protrusions, preferably threads and/or gripping bars, are embossed into the fiber product by embossing via the press pad device (2) or by using the stamp member (3). By doing so a screw cap with grooves that fit inside the container made according to the method of claim 1 may be used for sealing, or when with grooves that fit outside the container made according to said method, this is possible for usage when sealing. Using the stamp member (3) only may be preferred when embossing threads into the container made using said method. When doing such embossing the press pad device 2 and/or the stamp device 3 are adapted for providing threads when using the pressure and temperature as set out above.

According to a preferred embodiment of the press molding method as set out above for claim 1 it also comprises a gasket member (not shown in any figure) applied to a bottom portion (23) of stamp device (3), wherein said gasket member forms an inner part on top of said bottom part (11). Preferably said gasket member is at least partly elastic and compressible. At the same time there may be a second stamp member (4) forming said edge part (10).

According to a preferred embodiment of the method as set out above for claim 1 pre-expanded microspheres and/or expandable microspheres are added during the pressing or before the pressing commences, preferably wherein said pre-expanded microspheres and/or expandable microspheres has been added to the material before the pressing commences.

According to a preferred embodiment of the method as set out above for claim 1 said pre-expanded microspheres and/or expandable microspheres are treated from about 50 to about 150 °C, preferably from about 50 to about 120 °C, most preferred from about 60 to about 100 °C, thus providing a dry content of from about 50 to about 70% and thus providing an expanded or foamed product.

According to a preferred embodiment of the method as set out above for claim 1 steam is applied during said step for expanding said material.

The moisture content (set out for certain embodiments above) is an advantage during the press forming (c.f. the first aspect of the present invention—c.f. claim 1). Preferably said moisture is added before the pressing of the material (i.e. raw material) is achieved.

An important function in caps, lids or similar constructions made of fiber is compressability and shape stability. Through adding pre-expanded microspheres and/or expandable microspheres to the network of fibres the ability of the material after compression to bring back its shape, the so-called bounce back ability is increased. This can also be expressed so that the viscoelastic characteristics of the material can be influenced so that the tendency for time dependent deformation, co called “creep deformation” is decreased. The closed spheres may be added to e.g. paper sheet (material) in different ways. Pre-expanded microspheres and/or expandable microspheres may be added.

Said microspheres may be added during different stages of the manufacturing process. They may be added before the manufacturing of the fiber mat, but preferably they are added in connection with the manufacturing of the fiber mat. This may be done during dry or wet laying of the fiber mat. Microspheres may also be added in direct connection with the form pressing of the fiber mat. In case the product is to be used in the form of a closing member or sealing member in a container, extra fiber is added after the form pressing. Said material may be fiber material, preferably cellulosic, a polymeric material or a combination of these.

Microspheres may be added in expanded or in non-expanded form, or in a combination of both. The non-expanded spheres may fully or partly be expanded through heating in the manufacturing process of the fiber mat (wet or dry). The spheres may also be expanded through the heat that is conveyed to the pressing operation, alternatively, when a closed container before or directly in the filling or closing process (c.f. dairy operations when milk products are filled into containers, essentially made from cellulosic fibers, which subsequently are sealed).

The final products may then contain fully or partly expanded microspheres, alternatively spheres, which have been expanded and then compressed in the pressing operation.

According to a preferred embodiment of the method as set out above for claim 1 said expandable microspheres are thermally expandable thermoplastic microspheres or pre-expanded thermally expandable thermoplastic microspheres, or a combination thereof. The expandable thermoplastic microspheres can be of fossil based or bio-based polymer material. Examples of such expandable microspheres are microspheres marketed under the name Expancel Microspheres by Nouryon.

According to a preferred embodiment of the fiber press mould above, it comprises a releasable gasket member applied to a bottom portion (23) of said stamp device (3) wherein said gasket member forms an inner part on top of said bottom part (11) of the formed fiber product (1), wherein preferably said gasket member at least partly is elastic and compressible.

Also provided in the present application is a fiber product obtainable by the method according to claim 1 above or according to any one of the preferred embodiments mentioned above.

1. Press molding method of a fiber product, at high pressure and high temperature, by means of a press pad device (2) and a stamp device (3), said press pad device (2) including a cavity (22) having a generally horizontal bottom part (23) and generally vertical wall parts (24) of substantial height and said stamp device (3) including a generally horizontal bottom part (31) and generally vertical wall parts (34) wherein said fiber product (1) is produced from a substantially flat blank (5) in a gap formed between said bottoms (23, 31) and wall parts (24, 34), respectively and whereby said blank (5) after press molding will be cup shaped comprising a generally horizontal bottom part (11) and generally vertical wall parts (12) with an upper edge part (10), characterized by providing said generally vertical wall parts (24) of said pad device (2) with an angle (a) in relation to the vertical that is larger than the corresponding angle (B) of said generally vertical wall parts (34) of said stamp device (3) thereby forming an at least partly upwardly diverging gap shaping said generally vertical wall parts (12) wherein the material in the fiber product (1) comprises natural fibers such as natural fibers from wood, straw, such as bagasse, and/or recycled fiber or a combination thereof.

2. Press molding method according to claim 1, wherein an upper edge (10) of said fiber product (1) after forming at least said bottom part (11) is positioned within a cavity (22) of said press pad device (2), wherein preferably all parts of said upper edge (10) is positioned below an upper surface of the body (20) of said press pad device (2).

3. Press molding method according to claim 1, wherein an end position of the stamp device (3) stops pressing at a given distance in relation to a position of said press pad device (2) so that a given thickness (t11) is reached for said bottom part (11).

4. Press molding method according to claim 1, wherein a pressure also is put on the upper edge part (10), wherein preferably said pressure is different from pressure affecting the bottom part (11), wherein more preferred said pressure is applied by a separate additional stamp device (4).

5. Press molding method according to claim 1, wherein protrusions, preferably threads and/or gripping bars, are embossed into the fiber product by embossing by means of said press pad device (2) and/or by using said stamp device (3).

6. Press molding method according to claim 1, further comprising a gasket member applied to the bottom part (23) of stamp device (3), wherein said gasket member after pressing forms an inner part on top of said bottom part (11).

7. Press molding method according to claim 6 wherein said gasket member at least partly is elastic and preferably compressible.

8. Press molding method according to claim 1, wherein the temperature is from about 80 to about 250 °C, preferably from about 150 to about 250 °C, and the pressure on said bottom part (11) is at least 200 bar.

9. Press molding method according to claim 1, wherein the amount of water in the material does not exceed the amount of fiber, wherein preferably the weight of water in the material does not exceed 20% the weight of fiber.

10. Press molding method according to claim 1, wherein pre-expanded microspheres and/or expandable microspheres are added during the pressing or before the pressing commences, preferably wherein said pre-expanded microspheres and/or expandable microspheres have been added to the material before the pressing commences.

11. Press molding method according to claim 10, wherein said pre-expanded microspheres and/or expandable microspheres are treated from about 50 to about 150 °C, preferably from about 50 to about 120 °C, most preferred from about 60 to about 100 °C, thus providing a dry content of from about 50 to about 70% and thus providing an expanded or foamed product.

12. Press molding method according to claim 10 wherein steam is applied during said step for expanding said material.

13. A fiber product obtainable by the method according to claim 1.

14. A fiber press mould, comprising a press pad device (2) and a stamp device (3), arranged to form a cup shaped fiber product (1) comprising a bottom part (11) and generally vertical wall parts (12), characterized in that generally vertical wall parts (24) of said pad device (2) have an angle (a) in relation to the vertical that is larger than the corresponding angle (f) of said generally vertical wall parts (34) of said stamp device (3) thereby forming an at least partly upwardly diverging gap (22) shaping said generally vertical wall parts (12).

15. A fiber press mould according to claim 14 also comprising an additional stamp device (4), wherein said additional stamp device (4) preferably is independent of said first stamp member (3).

16. A fiber press mould according to claim 14 comprising a releasable gasket member applied to a bottom portion (23) of said stamp device (3) wherein said gasket member forms an inner part on top of said bottom part (11) of the formed fiber product (1), wherein preferably said gasket member at least partly is elastic and compressible.

17. A fiber product comprising a bottom part (11) and an edge part (10), characterized in that said edge part (10) has a higher density than said bottom part (11) and/or higher density than parts of a side wall (12) closer to the bottom part (11) than the edge part (10).
